(19) United States
(12) Patent Application Publication
(10) Pub. No.: US 2026/0253425 A1
(43) Pub. Date: Aug. 27, 2026

(54) PERCEPTION QUALITY EVALUATION OF AN OBJECT DETECTION SYSTEM

(71) Applicant: VIRGINIA TECH INTELLECTUAL PROPERTIES, INC., Blacksburg, VA (US)

(72) Inventors: Azim Eskandarian, Blacksburg, VA (US); Ce Zhang, Blacksburg, VA (US)

(21) Appl. No.: 19/161,481

(22) PCT Filed: Mar. 1, 2024
(86) PCT No.: PCT/US24/18128

§ 371 Date: Sep. 2, 2025

Related U.S. Application Data
(60) Provisional application No. 63/488,349, filed on Mar. 3, 2023.

(51) Int. Cl. G06V 20/58; G06T 7/00; G06V 10/46; G06V 10/764; G06V 10/766; G06V 10/77

(52) U.S. Cl. CPC G06V 20/58; G06T 7/0002; G06V 10/462; G06V 10/764; G06V 10/766; G06V 10/7715; G06T 2207/20081; G06T 2207/30168; G06V 2201/07

(57) ABSTRACT

Perception quality assessment concepts for an object detection system are described. An example method can include identifying true positive and/or false negative object detection data in object detection data generated by an object detection system based on an image. The method can also include generating a saliency map based on the image. The saliency map can include saliency intensity data corresponding to the image. The method can also include identifying true positive and/or false negative saliency intensity data in the saliency map based on the true positive and/or false negative object detection data, respectively. The method can also include calculating a perception quality metric (PQM) based on the true positive and/or false negative saliency intensity data. The PQM can be indicative of a degree of perception quality of the object detection system with respect to the image. The method can also include performing an operation based on the PQM.

### BACKGROUND

Humans can discern changes in their visual and sensing capabilities over time and can adjust their actions accordingly. Machines in the context of an autonomous or semi-autonomous environment use object detection systems to attempt to emulate such capabilities of a human. In particular, these machines use object detection systems to detect various objects in data that correspond to and are indicative of their surrounding environment. These machines then make decisions and perform operations based on the detected objects. For example, in the context of autonomous driving, connected and autonomous vehicles (CAVs) use object detection systems to detect objects such as people, vehicles, and traffic signals in data such as images or video that have been captured by their on-board perception sensors. The CAVs then make decisions and perform various driving related operations based on such detected objects.

### SUMMARY

The present disclosure is directed to dynamic and intelligent perception quality assessment of an object detection system. More specifically, described herein is a perception quality assessment framework that can be embodied or implemented as a software architecture to evaluate the perception quality of an object detection system. Based on such an evaluation, the perception quality assessment framework can be further implemented to generate a perception quality metric (PQM) that corresponds to the object detection system. The PQM can be indicative of a degree of perception quality corresponding to the object detection system. The perception quality assessment framework can be further implemented to train a model to predict the PQM.

According to an example of the perception quality assessment framework described herein, an object detection system can classify different objects in an image in one or more classes. A computing device can use ground truth data corresponding to the image to determine whether such classifications are correct or incorrect. Additionally, the computing device can generate a saliency map that corresponds to the image. Based on identifying one or more correct or incorrect classifications predicted by the object detection system, the computing device can identify saliency intensity data in the saliency map that respectively corresponds to such correct or incorrect classification(s). The computing device can then use such saliency intensity data to calculate a PQM that corresponds to and is indicative of a degree of perception quality of the object detection system.

In addition, the computing device can use the PQM to perform one or more operations. In one example, the computing device can perform at least one of an object detection system selection operation, a path planning operation, a control operation, a sensor selection operation, a sensor fusion operation, or another operation based on the PQM. In another example, the computing device can perform a regression learning process to train a model to predict the PQM based on the image. In this way, the perception quality assessment framework of the present disclosure can reduce at least one of the time, computational costs, or manual labor involved with performing a perception quality assessment for each of a plurality of different object detection systems.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a diagram of an example environment that can facilitate a perception quality assessment of an object detection system according to at least one embodiment of the present disclosure.

FIG. 2 illustrates a block diagram of an example computing environment that can facilitate a perception quality assessment of an object detection system according to at least one embodiment of the present disclosure.

FIG. 3 illustrates an example data flow diagram for perception quality assessment of an object detection system according to at least one embodiment of the present disclosure.

FIG. 4A illustrates an example of a saliency map that can be generated according to at least one embodiment of the present disclosure.

FIG. 4B illustrates an example of a modified saliency map that can be generated according to at least one embodiment of the present disclosure.

FIG. 5 illustrates an example data flow diagram for perception quality assessment of an object detection system according to at least one embodiment of the present disclosure.

FIG. 6A illustrates a block diagram of an example architecture of a pixel module that can be implemented to facilitate a perception quality assessment of an object detection system according to at least one embodiment of the present disclosure.

FIG. 6B illustrates a block diagram of an example architecture of a superpixel module that can be implemented to facilitate a perception quality assessment of an object detection system according to at least one embodiment of the present disclosure.

FIG. 7A illustrates a block diagram of an example architecture and data flow of an attention network encoder of a pixel module and a superpixel module that can be implemented to facilitate a perception quality assessment of an object detection system according to at least one embodiment of the present disclosure.

FIG. 7B illustrates a block diagram of another example architecture and data flow of an attention network encoder of a pixel module and a superpixel module that can be implemented to facilitate a perception quality assessment of an object detection system according to at least one embodiment of the present disclosure.

FIG. 8A illustrates a flow diagram of an example computer-implemented method that can be implemented to facilitate a perception quality assessment of an object detection system according to at least one embodiment of the present disclosure.

FIG. 8B illustrates a flow diagram of another example computer-implemented method that can be implemented to facilitate a perception quality assessment of an object detection system according to at least one embodiment of the present disclosure.

### DETAILED DESCRIPTION

As noted above, machines use object detection systems to detect various objects in data that correspond to and are indicative of their surrounding environment. These machines then make decisions and perform operations based on the detected objects. However, these machines and object detection systems do not have a measure or metric of how good or how bad their perception of their surrounding environment truly is. Additionally, at present, there is not a model that can predict the PQM of an object detection system.

Some existing technologies in the field of computer vision use object detection systems that employ neural networks to detect objects in images. However, these existing technologies do not assess the detection accuracy of the object detection systems with respect to each image, nor do they provide any feedback to the object detection systems regarding their detection accuracy.

Some existing technologies in the field of computer vision assess an image's overall quality based on blind image quality assessment (IQA). However, for at least a few reasons, these technologies cannot be directly applied to achieve perceptual quality feedback in an autonomous or semi-autonomous environment such as, for instance, an autonomous driving environment or a robotics-based environment. First, the IQA score is based on manual feature extraction and classification instead of predictions made by an object detection system. Second, the IQA score is highly affected by image shape such as stretching and rotation, which is usually applied as a data augmentation method for training object detection algorithms used by object detection systems. Third, the IQA score does not take the image content into account, such as the number of vehicles, occluded objects, object distance, or other image content.

Additionally, some existing technologies in the field of computer vision use computational models such as neural networks to perform the blind IQA. However, the model processing speed associated with these technologies is often too slow for use in, for instance, an autonomous driving environment. Further, these technologies also require relatively large training datasets to train such models, and thus, are computationally expensive.

The present disclosure provides solutions to address the above-described problems associated with perception quality assessment of object detection systems in general and with respect to the approaches used by existing technologies. The perception quality assessment framework described herein can be implemented to evaluate the perception quality of an object detection system, generate a PQM that is indicative of a degree of such perception quality, and further train a model to predict the PQM. Additionally, the perception quality assessment framework can be implemented in an offline or online environment to evaluate the perception accuracy of various object detection systems. Further, the perception quality assessment framework allows for an agent using a variety of object detection systems to elect to use one or more specific object detection systems to make relatively safer and more reliable trajectory and control action decisions based on their respective PQMs.

The perception quality assessment framework of the present disclosure provides several technical benefits and advantages. For example, the perception quality assessment framework described herein can allow for the offline or online assessment of the perception quality of different object detection systems based on one or more images used by such object detection systems to detect and classify objects in such images. In addition, the perception quality assessment framework can reduce the time and costs (e.g., computational costs, manual labor costs) associated with training a machine learning or artificial intelligence model that, once trained, can be used in an online environment to predict, in real-time or near real-time, the PQMs for a plurality of different object detection systems.

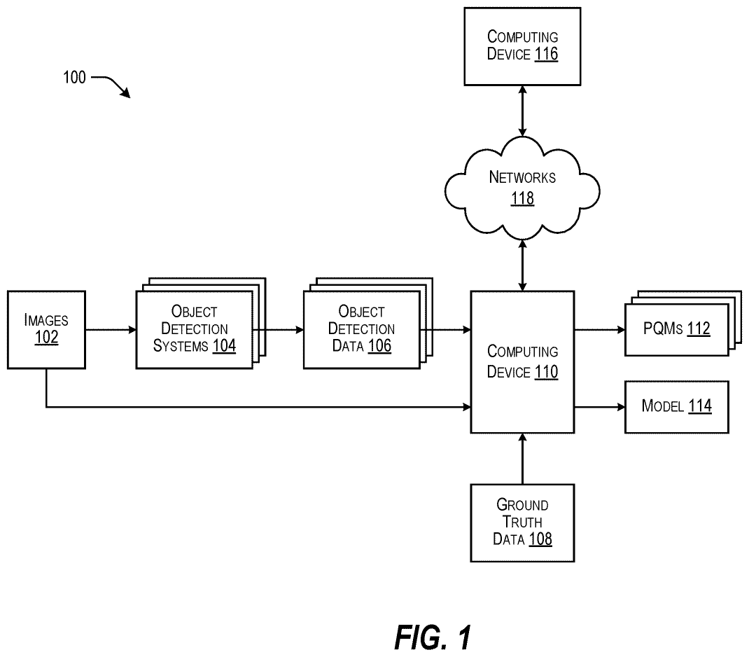

For context, FIG. 1 illustrates a diagram of an example environment 100 that can facilitate a perception quality assessment of an object detection system according to at least one embodiment of the present disclosure. The environment 100 can be embodied or implemented as a computing environment in which a computing device can evaluate the perception quality of an object detection system, generate a PQM that is indicative of a degree of such perception quality, and further train a model to predict the PQM.

In one example, the environment 100 can be embodied or implemented as an offline computing environment in which the perception quality assessment, PQM generation, and model training can be performed. However, the perception quality assessment framework of the present disclosure is not limited to such an environment. In other examples, the environment 100 can be embodied or implemented as an online, real-time, or near real-time computing environment in which object detection operations are performed by an agent that also performs various planning or control operations, among others, based on the object detection operations. For example, the environment 100 can be embodied or implemented as an automated or semi-automated computing environment having an agent that can implement object detection methods to facilitate such planning or control operations, among others. Overall, the environment 100 can be embodied or implemented as a connected and autonomous driving environment, an automated or semi-automated manufacturing or production environment, an automated or semi-automated robotics-based environment, or another automated or semi-automated computing environment.

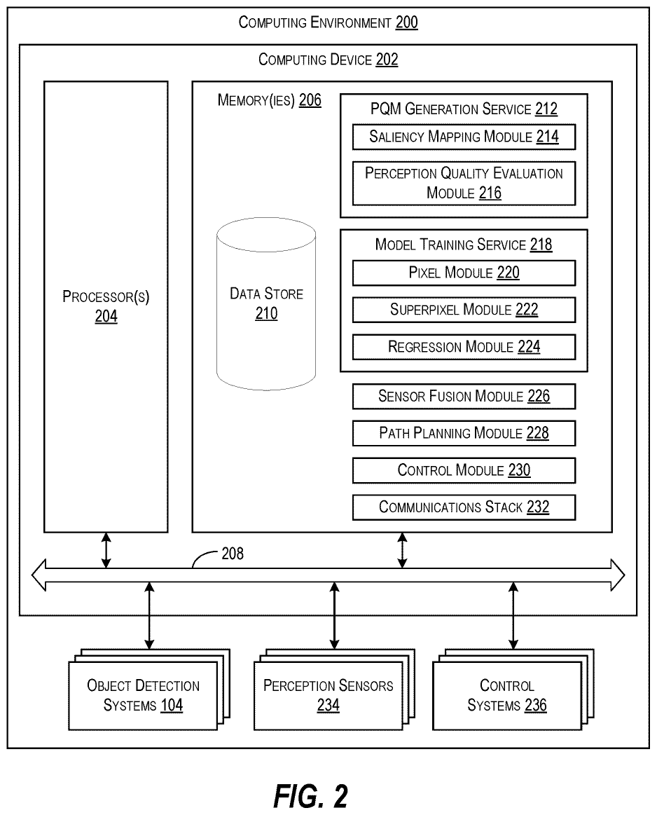

As illustrated in FIG. 1, the environment 100 operates on one or more images 102 that can be input to one or more object detection systems 104. The images 102 are representative of one image, a number of images, or a number of images in a stream of images, such as in a video stream. The environment 100 can process one or more of the images 102 in a sequential or concurrent manner. The images 102 can be generated by one or more perception sensors, including the perception sensors 234 described below with reference to FIG. 2, such as one or more image sensors or related systems, laser-based sensors or related systems, Light Detection And Ranging (LiDAR) sensors or related systems, other types of sensors or systems, or combinations thereof. The data format of the images 102 can vary based, for example, on the type of sensor or system that generated each of the images 102. As such, the data format for a first image 102 among the images 102 can vary as compared to a second image 102 among the images 102, particularly if the first image 102 was generated by an image sensor and the second image was generated by a LiDAR sensor. In some cases, data from one or more of the sensors can be fused or combined together to form a single image 102.

The object detection systems 104 can each be embodied or implemented as, for instance, one or more vison-based object detection systems. Examples of the object detection systems 104 can include camera-based object detection systems, image or video-based object detection systems, laser-based object detection systems, multi-dimensional object detection systems, LiDAR-based object detection systems, other types of object detection systems, or any combination thereof. In some cases, the object detection systems 104 can be implemented as a single or combined object detection system 104 that incorporates a number of different types of object detection systems.

The object detection systems 104 can each implement a machine learning (ML) model, an artificial intelligence (AI) model, a related model, or a combination thereof to individually detect and classify one or more objects in an image 102. For instance, the object detection systems 104 can each implement an object detection algorithm such as, for example, a neural network (NN), a convolutional neural network (CNN), a you only look once (YOLO) object detection algorithm, or another type of object detection algorithm that can be implemented to detect and classify one or more objects in the images 102, or any combination of such networks and/or algorithms. In one example, the object detection systems 104 can each implement the YOLOv4 object detection algorithm to individually detect and classify objects in the image 102.

After detecting and classifying one or more objects in the image 102, each of the object detection systems 104 can respectively generate object detection data 106. The object detection data 106 generated by each of the object detection systems 104 can include one or more class label predictions (also referred to as “classification(s)”). The class label predictions respectively correspond to one or more objects in the image 102 that have been independently detected and classified in a certain class by the object detection systems 104. More specifically, the object detection data 106 output by each of the object detection systems 104 can include one or more class label predictions or classifications that respectively correspond to one or more regions in the image 102 that have been independently detected and classified by each of the object detection systems 104. Each detected and classified region contains an object that has also been detected and classified in the same class as the region in which it is contained.

The object detection data 106 output by each of the object detection systems 104 can include an annotated version of the image 102. In one example, the annotated version of the image 102 can include annotations in the form of bounding boxes. Each bounding box can be indicative of and correspond to a region in the image 102 that has been detected and classified in a certain class by an object detection system of the object detection systems 104. Each bounding box can include an object that has also been detected and classified by the object detection system in the same class as the region noted above. When referenced herein in the context of classification operations, the terms “region,” “bounding box,” and “object” may be used interchangeably. For example, the classification of a “region” in the image 102 or a “bounding box” in the object detection data 106 can refer to the classification of an “object” in the image 102 and vice versa.

In one example, the above-described annotated version of the image 102 can further include annotations in the form of one or more classification probabilities that respectively correspond to one or more bounding boxes. The classification probabilities can each be indicative of a likelihood that a classified region, its corresponding bounding box, and the object contained therein have been accurately classified by an object detection system among the object detection systems 104. As such, each classification probability can be indicative of a confidence score that represents how confident such an object detection system is with its classification of a certain region in the image 102, its corresponding bounding box, and the object contained therein.

In the example depicted in FIG. 1, the environment 100 can further include a computing device 110. The computing device 110 can be embodied or implemented as, for example, a client computing device, a peripheral computing device, or both. Examples of the computing device 110 can include a computer, a general-purpose computer, a special-purpose computer, a laptop, a tablet, a smartphone, another client computing device, or any combination thereof. The computing device 110 can be operatively coupled, communicatively coupled, or both, to the object detection systems 104, such that each of the object detection systems 104 can respectively provide their object detection data 106 to the computing device 110.

As illustrated in the example depicted in FIG. 1, the computing device 110 can receive the image 102, the object detection data 106 generated by each of the object detection systems 104, and ground truth data 108. The ground truth data 108 can include a ground truth label for each region in the image 102. The ground truth label is also referred to as a “ground truth class label” or a “ground truth classification.” The ground truth label for each region in the image 102 can also correspond to the object contained in each region. Thus, the ground truth data 108 can include a ground truth label for each object in the image 102.

The ground truth data 108 can be generated in advance based on the image 102. Specifically, the ground truth data 108 can be generated such that each ground truth label in the ground truth data 108 is indicative of a correct, ground truth classification of a region in the image 102 and the object contained in such a region. In one example, the ground truth data 108 can include an open-source machine learning training dataset. For example, the ground truth data 108 can include at least one of the Berkley Deep Drive (BDD100k) dataset, the Karlsruhe Institute of Technology and Toyota Technological Institute (KITTI) dataset, the nuTonomy scenes (nuScenes) dataset, or another open-source machine learning training dataset. In some cases, the ground truth data 108 can include an open-source machine learning training dataset other than the BDD100k, KITTI, or nuScenes datasets. In some cases, the ground truth data 108 can be created based on one or more images of real-world conditions such as, for instance, images of real-world driving conditions.

The computing device 110 can perform a perception quality assessment or assessments on any or all of the object detection systems 104 in accordance with example embodiments described herein. The computing device 110 can perform such perception quality assessments of the object detection systems 104 based on the image 102, the object detection data 106 generated by each of the object detection systems 104 being assessed, and the ground truth data 108. In performing each perception quality assessment of the object detection systems 104, the computing device 110 can generate a perception quality metric (PQM) 112 for each of the object detection systems 104 that have been evaluated. The PQMs 112 can each be indicative of a degree of perception quality of a certain object detection system among the object detection systems 104 that has been evaluated with respect to the image 102.

Although the computing device 110 can respectively perform a perception quality assessment for each of the object detection systems 104, various examples of the present disclosure describe the perception quality assessment and PQM generation processes with respect to a single object detection system among the object detection systems 104. In these examples, the computing device 110 performs the perception quality assessment and PQM generation processes using a single set of the object detection data 106. These examples further describe the computing device 110 generating a single PQM among the PQMs 112 based on the perception quality assessment of the object detection system 104.

To compute a PQM 112, the computing device 110 can compare object detection data 106 generated by an object detection system 104 with the ground truth data 108. Based on such a comparison, the computing device 110 can identify at least one of true positive object detection data or false negative object detection data in the object detection data 106.

More specifically, to compute the PQM 112, the computing device 110 can compare the object detection data 106 with the ground truth data 108 to determine whether the object detection data 106 includes any true positive (correct) classification or false negative (incorrect) classification of any region and corresponding object in the image 102 that have been classified by the object detection system 104. For example, the computing device 110 can compare at least one class label prediction respectively corresponding to at least one bounding box in the object detection data 106 with one or more corresponding ground truth labels in the ground truth data 108. Based on such a comparison, the computing device 110 can determine whether such class label prediction made by the object detection system 104 is a true positive prediction or a false negative prediction. In this way, the computing device 110 can thereby identify at least one of true positive or false negative object detection data in the object detection data 106.

As described in further detail herein with reference to the example embodiments depicted in FIGS. 2, 3, 4A, 4B, 5, 6A, 6B, 7A and 7B, to compute the PQM 112, the computing device 110 can further generate a saliency map based on the image 102. For instance, the computing device 110 can perform a fine-grained saliency mapping process using the image 102 to generate a fine-grained saliency map having saliency intensity data corresponding to the image 102. The saliency intensity data can include at least one of image saliency intensity data corresponding to the image 102 as a whole or object saliency intensity data corresponding to one or more objects in the image 102. In one example, the computing device 110 can use Equations (1), (2), (3), and (4) described below with reference to the example depicted in FIG. 2 to calculate the image saliency intensity data and the object saliency intensity data.

The image saliency intensity data noted above can be indicative of pixel intensities corresponding to the image 102 as a whole, including pixel intensities for “non-target” objects, such as surrounding vegetation and buildings, among other types of objects. The object saliency intensity data can be indicative of pixel intensities corresponding to one or more “target” objects in the image 102 such as vehicles, people, traffic signals, and road signs, among others. In one example, the “non-target” objects can be objects in the image 102 that are relatively less important than “target” objects in the image 102 for purposes of object detection and classification operations. In another example, the “non-target” objects can be objects in the image 102 that do not correspond to ground truth labels in the ground truth data 108, while the “target” objects can be objects in the image 102 that do correspond to ground truth labels in the ground truth data 108.

To compute the PQM 112, the computing device 110 can further identify at least one of true positive saliency intensity data or false negative saliency intensity data in the fine-grained saliency map based on at least one of the above-described true positive or false negative object detection data, respectively. For example, based on identifying the true-positive and/or false negative object detection data in the object detection data 106, the computing device 110 can further identify saliency intensity data in the fine-grained saliency map that respectively corresponds to such true-positive and/or false negative object detection data. For instance, the computing device 110 can identify at least one of image or object saliency intensity data in the fine-grained saliency map that respectively corresponds to such true-positive and/or false negative object detection data.

In one example, the computing device 110 can identify saliency intensity data in the fine-grained saliency map that respectively corresponds to one or more true-positive bounding box classifications and/or one or more false negative bounding box classifications made by the object detection system 104 in the object detection data 106. In this way, the computing device 110 can identify true positive and/or false negative saliency intensity data in the fine-grained saliency map that respectively corresponds to bounding boxes in the object detection data 106 that have been correctly or incorrectly classified, respectively, by the object detection system 104.

In one example, the true positive saliency intensity data noted above can include at least one of true positive image saliency intensity data or true positive object saliency intensity data that respectively corresponds to at least one bounding box in the object detection data 106 that has been correctly classified by the object detection system 104. In another example, the false negative saliency intensity data noted above can include at least one of false negative image saliency intensity data or false negative object saliency intensity data that respectively corresponds to at least one bounding box in the object detection data 106 that has been incorrectly classified by the object detection system 104.

Based on identifying the true positive and/or false negative saliency intensity data in the fine-grained saliency map as described above, the computing device 110 can then use such data to calculate the PQM 112. In one example, the computing device 110 can use Equation (5) described below with reference to the example depicted in FIG. 2 to calculate the PQM 112 based on such true positive and/or false negative saliency intensity data that can been identified by the computing device 110 in the fine-grained saliency map. In some cases, the computing device 110 can use Equation (5) to calculate the PQM 112 based on at least one of the above-described image saliency intensity data, object saliency intensity data, true positive image saliency intensity data, true positive object saliency intensity, false negative image saliency intensity data, or false negative object saliency intensity.

Additionally, in some examples, based on identifying the true positive and/or false negative saliency intensity data in the fine-grained saliency map as described above, the computing device 110 can then use such data to create a modified saliency map. For example, the computing device 110 can create a modified version of the original fine-grained saliency map described above that can be generated by the computing device 110 based on the image 102.

In one example, the computing device 110 can create a modified fine-grained saliency map that is an annotated version of the original fine-grained saliency map. In some cases, the computing device 110 can create the modified fine-grained saliency map such that it denotes any true positive or false negative object detection data that has been correctly or incorrectly classified, respectively, by the object detection system 104 in the object detection data 106. For instance, the computing device 110 can create the modified fine-grained saliency map such that it denotes the above-described true positive and/or false negative saliency intensity data that can be identified by the computing device 110 in the original fine-grained saliency map.

After calculating the PQM 112, the computing device 110 can perform one or more operations based on the PQM 112. For example, based on the PQM 112, the computing device 110 can elect to use, or to not use, the object detection system 104 to detect and classify objects in one or more other images among the images 102. For instance, the computing device 110 can compare a first PQM 112 associated with a first object detection system 104 to a second, different PQM 112 among the PQMs 112 that has been generated by a second, different object detection system 104 among the object detection systems 104 based on the same image 102. In this example, the second PQM can be indicative of a second, different degree of perception quality of the second object detection system 104 with respect to the same image 102. In this example, based on comparing the first PQM 112 to the second PQM 112, the computing device 110 can then elect to use one, both, or neither of the first and second object detection systems 104 to detect and classify objects in one or more other images 102 that are different from the image 102.

In some cases, the object detection system 104 and the computing device 110 can be included in or coupled (e.g., communicatively, operatively) to an agent such as, for instance, an automated or semi-automated computer-based system or device. As an example, the object detection system 104 and the computing device 110 can be included in or coupled to an agent such as, for instance, a connected and autonomous vehicle (CAV) or a robotic device. In this example, based on one or more of the PQMs 112, the computing device 110 can perform or facilitate the performance of at least one of a path planning operation, a control operation, a sensor selection operation, a sensor fusion operation, or another operation associated with the agent based on the PQMs 112.

For example, if the computing device 110 determines that a PQM 112 for one image 102 is indicative of a relatively high degree of perception quality for the object detection system 104, the computing device 110 can use the object detection system 104 to detect and classify objects in different images 102 that were captured by one or more sensors of the agent. For example, the computing device 110 can use the object detection system 104 to detect and classify objects in different images 102 that were captured by a single sensor or different sensors of the agent. In this example, the object detection system 104 can generate additional object detection data based on such different images 102. The additional object detection data can have the same format as that of the object detection data 106 described above, although it can be generated based on the different images 102 captured by a single sensor or different sensors of the agent. In this example, the computing device 110 can then perform at least one of a path planning operation, a control operation, a sensor selection operation, or a sensor fusion operation based on such additional object detection data provided by the object detection system 104.

In one example, the computing device 110 can elect to implement the object detection system 104 based on the PQM 112 and then use the above-described additional object detection data provided by the object detection system 104 for one or more different images to generate a proposed path for the agent to navigate. In another example, the computing device 110 can elect to implement the object detection system 104 based on the PQM 112 and then use the additional object detection data to perform a control operation associated with the agent such as, for instance, an acceleration, braking, or turning operation. Alternatively, the computing device 110 can use the additional object detection data to instruct a control system of the agent to perform such a control operation.

In another example, an image 102 can be captured by a specific sensor of the agent. In this example, the computing device 110 can determine that the PQM 112 is indicative of a relatively high degree of perception quality of the object detection system 104 with respect to images captured by such a specific sensor. In this example, the computing device 110 can elect to implement the object detection system 104 in conjunction with such a specific sensor based on such a relatively high degree of perception quality indicated by the PQM 112.

In another example, an image 102 can be generated, at least in part, by fusing data from one or more specific sensors of the agent. In this example, the computing device 110 can determine that the PQM 112 is indicative of a relatively high degree of perception quality of the object detection system 104 with respect to the image 102 that was generated by fusing data from the specific sensors. In this example, the computing device 110 can elect to implement the object detection system 104 using images generated by fusing data from such specific sensors based on such a relatively high degree of perception quality indicated by the PQM 112.

As another example, upon calculating the PQM 112 for an image 102, the computing device 110 can define and train a model 114 to predict the PQM 112 based on the image 102. For instance, the computing device 110 can define the model 114 as an ML and/or AI model such as, for example, a neural network regression model. More specifically, in one example, the computing device 110 can define the model 114 as a superpixel attention-based regression neural network.

As described in detail herein with reference to the examples illustrated in FIGS. 2, 5, 6A, 6B, 7A, and 7B, the computing device 110 can define and train the model 114 to predict the PQM 112 based on one or more of the images 102 by performing a regression learning process. In such a regression learning process, each of the images 102 can be representative of input training data for the model 114 and the PQM 112 is representative of a ground truth label for the model 114. The computing device 110 can perform such a regression learning process to train the model 114 to predict the PQM 112 based on local features extracted from defined subsets of pixels in images 102 and general features extracted from superpixel segmentations of pixels in the images 102.

Defined subsets of pixels in images 102 are also referred to herein as “image patches,” and the superpixel segmentations of pixels in images 102 are also referred to herein as “superpixel patches.” Each of the superpixel segmentations or “superpixel patches” can be a set of pixels that are all similar to one another with respect to a certain characteristic or computed property. For instance, the pixels in each superpixel segmentation can all have the same or similar pixel intensity, color, texture, or other characteristic or computed property.

In performing the regression learning process described herein to train the model 114 to predict the PQM 112 based on an image 102, the computing device 110 can implement a pixel module to extract the local features from the defined subsets of pixels in the image 102 using a pixel-based attention module. In performing the regression learning process, the computing device 110 can also implement a superpixel module to extract the general features from the superpixel segmentations of pixels in the image 102 using a superpixel-based attention module. In performing the regression learning process, the computing device 110 can further implement a regression module to regress on the PQM 112 based on the local features and the general features. Further details describing the regression learning process, the pixel module, the pixel-based attention module, the superpixel module, the superpixel-based attention module, and the regression module are provided below with reference to the examples depicted in FIGS. 2, 5, 6A, 6B, 7A, and 7B.

Once trained, the model 114 can be implemented by, for instance, the computing device 110 or another computing device described herein to predict any of the PQM(s) 112 that respectively correspond to any of the object detection systems 104. In this way, the perception quality assessment framework of the present disclosure can reduce at least one of the time, computational costs, or manual labor involved with performing a perception quality assessment for each of the object detection systems 104.

In examples where the environment 100 is embodied or implemented as an online or real-time computing environment, the environment 100 can further include a computing device 116. The computing device 116 can be communicatively coupled, operatively coupled, or both, to the computing device 110 by way of one or more networks 118. In some of these examples, the computing device 116 can be embodied or implemented as, for instance, a server computing device, a virtual machine, a supercomputer, a quantum computer or processor, another type of computing device, or any combination thereof. Alternatively, in some of these examples, the computing device 116 can be embodied or implemented as a client or peripheral computing device such as, for instance, a computer, a general-purpose computer, a special-purpose computer, a laptop, a tablet, a smartphone, another client computing device, or any combination thereof.

The networks 118 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 110 and the computing device 116 can communicate data with one another over the networks 118 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over networks 118, without limitation. Although not illustrated, networks 118 can also include connections to any number of other network hosts, such as website servers, file servers, networked computing resources, databases, data stores, or other network or computing architectures in some cases.

The computing device 116 can implement one or more aspects of the perception quality assessment framework of the present disclosure in accordance with at least one example described herein. For example, in some cases, the computing device 110 can offload at least some of its processing workload to the computing device 116 via the networks 118. For instance, the computing device 110 can send the image 102, the object detection data 106, and the ground truth data 108 to the computing device 116. The computing device 116 can then use the image 102, the object detection data 106, and the ground truth data 108 to perform one or more of the above-described operations to generate any of the PQMs 112 and/or the model 114.

In one example, the computing device 116 can perform the above-described perception quality evaluation for any or all of the object detection systems 104 based on one or more of the images 102, the object detection data 106 generated by one or more of the object detection systems 104 being evaluated, and the ground truth data 108. Based on performing such perception quality evaluations, the computing device 116 can generate one or more of the PQMs 112 that respectively correspond to one or more of the object detection systems 104 that have been evaluated. In another example, the computing device 116 can define and train the model 114 based on one or more of the PQMs 112 corresponding to one or more of the object detection systems 104. The computing device 116 can define and train the model 114 such that it can predict PQMs 112 based on one or more of the images 102.

In some cases, the computing device 116 can be embodied or implemented as a client or peripheral computing device that has the same attributes and functionality as that of the computing device 110. In these examples, the object detection systems 104 and the computing device 116 can be included in or coupled (e.g., communicatively, operatively) to an agent such as, for instance, a CAV or a robotic device. In these examples, the computing device 110 can use the networks 118 to send the computing device 116 any or all of the PQMs 112 respectively corresponding to any or all of the object detection systems 104.

In the examples above, after using one or more of the PQMs 112 to determine that a specific object detection system 104 among the object detection systems 104 has a relatively high degree of perception quality, the computing device 116 can elect to use this particular object detection system to perform object detection operations. In these examples, the computing device 116 can then use the object detection data generated thereafter by the object detection system 104 to perform or facilitate the performance of at least one of a path planning operation, a control operation, a sensor selection operation, a sensor fusion operation, or another operation associated with the agent. For instance, the computing device 116 can perform or facilitate the performance of such operation(s) in the same or similar manner as described above with respect to the computing device 110.

In the examples above where the object detection systems 104 and the computing device 116 can be included in or coupled to an agent such as, for instance, a CAV or a robotic device, the computing device 110 can also use the networks 118 to send the model 114 to the computing device 116. In these examples, the computing device 116 can then implement the model 114 to predict the PQMs 112 for the object detection systems 104. If the computing device 116 determines that any of the object detection systems 104 have a relatively high degree of perception quality based on the PQMs 112 predicted by the model 114, the computing device 116 can then elect to use such object detection systems 104 to perform object detection operations. In these examples, the computing device 116 can then use the object detection data respectively generated thereafter by such object detection systems 104 to perform or facilitate the performance of at least one of a path planning operation, a control operation, a sensor selection operation, a sensor fusion operation, or another operation associated with the agent as described above.

FIG. 2 illustrates a block diagram of an example computing environment 200 that can facilitate a perception quality assessment of an object detection system according to at least one embodiment of the present disclosure. The computing environment 200 can include or be coupled (e.g., communicatively, operatively) to a computing device 202. With reference to FIGS. 1 and 2 collectively, in the examples described herein, the computing environment 200 can be used, at least in part, to embody or implement one or more components of the environment 100. In these examples, the computing device 202 can be used, at least in part, to embody or implement at least one of the computing device 110 or the computing device 116.

The computing device 202 can include at least one processing system, for example, having at least one processor 204 and at least one memory 206, both of which can be coupled (e.g., communicatively, electrically, operatively) to a local interface 208. The memory 206 can include a data store 210, a PQM generation service 212, a saliency mapping module 214, a perception quality evaluation module 216, a model training service 218, a pixel module 220, a superpixel module 222, a regression module 224, a sensor fusion module 226, a path planning module 228, a control module 230, and a communications stack 232 in the example shown. The computing device 202 can also be coupled (e.g., communicatively, electrically, operatively) by way of the local interface 208 to the object detection systems 104, one or more perception sensors 234, and one or more control systems 236. The computing environment 200 and the computing device 202 can also include other components that are not illustrated in FIG. 2. In some cases, the object detection systems 104 can be implemented as one or more functional modules of the computing device 202, similar to the PQM generation service 212 and the model training service 218.

In some cases, the computing environment 200, the computing device 202, or both may or may not include all the components illustrated in FIG. 2. For example, in some cases, depending on how the computing environment 200 is embodied or implemented, the computing environment 200 may omit at least one of the object detection systems 104, the perception sensors 234, or the control systems 236, and thus, the computing device 202 may or may not be coupled to one or more of such components. Also, in some cases, depending on how the computing device 202 is embodied or implemented, the memory 206 may or may not include at least one of the sensor fusion module 226, the path planning module 228, the control module 230, or other components.

Where the environment 100 is embodied or implemented as an offline computing environment, the computing environment 200 can be used, at least in part, to embody or implement the environment 100 and the object detection systems 104. Additionally, in this example, the computing device 202 can be used, at least in part, to embody or implement the computing device 110 such that the memory 206 includes all of the modules of the PQM generation service 212 and the model training service 218, as well as the communications stack 232.

Where the environment 100 is embodied or implemented as an online computing environment and the computing device 116 is embodied or implemented as a server computing device, the computing environment 200 can be used, at least in part, to embody or implement the environment 100 and the object detection systems 104. Additionally, in this example, the computing device 202 can be used, at least in part, to embody or implement at least one of the computing device 110 or the computing device 116 such that the memory 206 includes all of the modules of the PQM generation service 212 and the model training service 218, as well as the communications stack 232.

Where the environment 100 is embodied or implemented as an online, automated, or semi-automated computing environment having an agent that can implement object detection methods to facilitate various operations as described above with reference to FIG. 1, the computing environment 200 can be used, at least in part, to embody or implement the agent. For instance, the agent can include the computing device 110, the object detection systems 104, the perception sensors 234, and the control systems 236, among other components. In this example, the computing device 110 can be coupled to the object detection systems 104, the perception sensors 234, and the control systems 236. In this example, the computing device 202 can be used, at least in part, to embody or implement the computing device 110 such that the memory 206 includes all of the modules of the PQM generation service 212 and the model training service 218, as well as the sensor fusion module 226, the path planning module 228, the control module 230, and the communications stack 232.

The processor 204 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 204 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 206 can be embodied as one or more memory devices and store data and software or executable-code components executable by the processor 204. For example, the memory 206 can store executable-code components associated with the PQM generation service 212, the saliency mapping module 214, the perception quality evaluation module 216, the model training service 218, the pixel module 220, the superpixel module 222, the regression module 224, the sensor fusion module 226, the path planning module 228, the control module 230, and the communications stack 232 for execution by the processor 204. The memory 206 can also store data such as the data described below that can be stored in the data store 210, among other data. For instance, the memory 206 can also store the image 102, the object detection algorithms implemented by the object detection systems 104, the object detection data 106, the ground truth data 108, the PQMs 112, the model 114, or any combination thereof.

The memory 206 can store other executable-code components for execution by the processor 204. For example, an operating system can be stored in the memory 206 for execution by the processor 204. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 206 can store software for execution by the processor 204. In this respect, the terms “executable” or “for execution” refer to software forms that can ultimately be run or executed by the processor 204, whether in source, object, machine, or other form. Examples of executable programs include, for instance, a compiled program that can be translated into a machine code format and loaded into a random access portion of the memory 206 and executed by the processor 204, source code that can be expressed in an object code format and loaded into a random access portion of the memory 206 and executed by the processor 204, source code that can be interpreted by another executable program to generate instructions in a random access portion of the memory 206 and executed by the processor 204, or other executable programs or code.

The local interface 208 can be embodied as a data bus with an accompanying address/control bus or other addressing, control, and/or command lines. In part, the local interface 208 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 210 can include data for the computing device 202 such as, for instance, one or more unique identifiers for the computing device 202, digital certificates, encryption keys, session keys and session parameters for communications, and other data for reference and processing. The data store 210 can also store computer-readable instructions for execution by the computing device 202 via the processor 204, including instructions for the PQM generation service 212, the saliency mapping module 214, the perception quality evaluation module 216, the model training service 218, the pixel module 220, the superpixel module 222, the regression module 224, the sensor fusion module 226, the path planning module 228, the control module 230, and the communications stack 232. In some cases, the data store 210 can also store the image 102, the object detection algorithms implemented by the object detection systems 104, the object detection data 106, the ground truth data 108, the PQMs 112, the model 114, or any combination thereof.

The PQM generation service 212 can be embodied as one or more software applications or services executing on the computing device 202. For example, the PQM generation service 212 can be embodied as and can include the saliency mapping module 214, the perception quality evaluation module 216, another module, or a combination thereof. The PQM generation service 212 can be executed by the processor 204 to implement (e.g., execute) at least one of the saliency mapping module 214 or the perception quality evaluation module 216. Each of the saliency mapping module 214 and the perception quality evaluation module 216 can also be respectively embodied as one or more software applications or services executing on the computing device 202. In one example, the PQM generation service 212 can be executed by the processor 204 to generate a saliency map based on the image 102, create a modified version of the saliency map, and calculate the PQM 112 using the saliency mapping module 214 and the perception quality evaluation module 216 as described below.

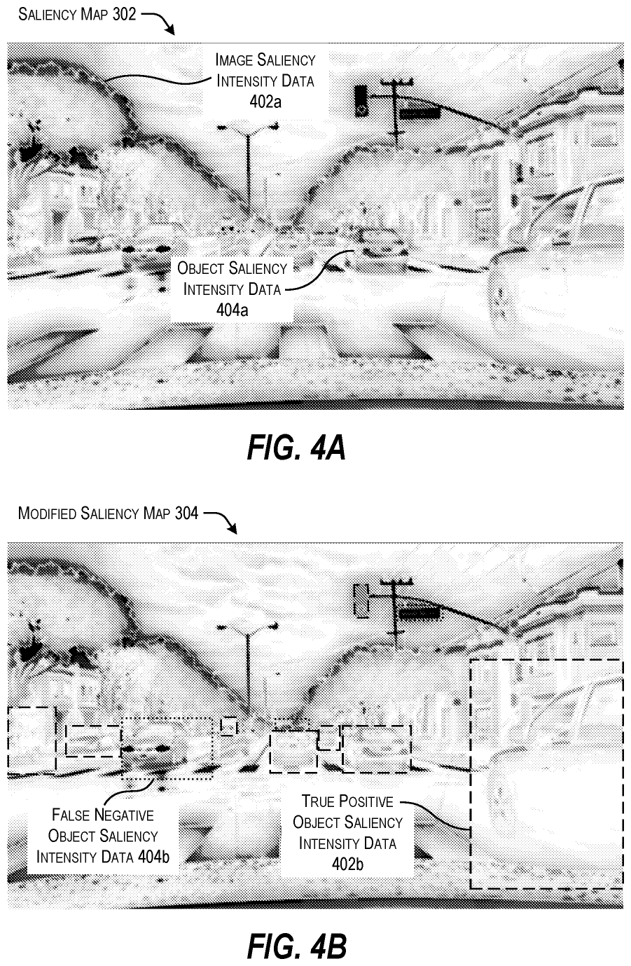

The saliency mapping module 214 can be embodied as one or more software applications or services executing on the computing device 202. The saliency mapping module 214 can be executed by the processor 204 to generate the fine-grained saliency map described above with reference to FIG. 1. The saliency mapping module 214 can generate the fine-grained saliency map based on the image 102 such that the fine-grained saliency map includes the above-described image and object saliency intensity data corresponding to objects in the image 102. For example, using the image 102 as input, the saliency mapping module 214 can generate a fine-grained saliency map having image and object saliency intensity data that is similar to that of saliency map 302 described below and illustrated in FIG. 4A.

To generate the fine-grained saliency map described above, the saliency mapping module 214 can perform a fine-grained saliency mapping process based on an image 102 to generate the above-described image and object saliency intensity data corresponding to objects in the image 102. In performing the fine-grained saliency mapping process, the saliency mapping module 214 can extract features from the image 102, convert the image 102 to an intensity-based image, and transform the intensity-based image to different scales. The saliency mapping module 214 can then obtain the image and object saliency intensity data using Equations (1), (2), (3), and (4) defined below.

$${I}_{total} ( x , y ) = \sum {I}_{s u b} ( x , y ) , \qquad ( 1 )$$

where I_{sub}(x, y) is the submap intensity and Iₜₒₜₐₗ(x, y) is the total map intensity. To compute the submap intensity, the saliency mapping module 214 can use Equation (2) defined below.

$${I}_{s u b} ( x , y ) = max \{ c ( x , y ) - σ ( x , y , ζ ) , 0 \} , \qquad ( 2 )$$

where c(x, y) represents the center and σ(x, y, ζ) is the surroundings. To obtain c(x, y) and σ(x, y, ζ), the saliency mapping module 214 can use Equations (3) and (4) defined below.

$$c ( x , y ) = i ( x , y ) \qquad ( 3 )$$

$$σ ( x , y , ζ ) = \frac{rectSum ( ( x - ζ , y - ζ , x + ζ , y + ζ ) - i ( x , y ) )}{{( 2 ζ + 1 )}^{2} - 1} , \qquad ( 4 )$$

where rectSum is the rectangular sum, i(x, y) is the intensity of the corresponding pixel, and ζ is the filtering window size.

The perception quality evaluation module 216 can be embodied as one or more software applications or services executing on the computing device 202. The perception quality evaluation module 216 can be executed by the processor 204 to calculate the PQM 112 corresponding to the object detection system 104, or any of the PQM(s) 112 respectively corresponding to any of the object detection system(s) 104, based on the image 102.

The accuracy of each of the object detection systems 104 is affected by two factors, the background image properties and the target object properties. The background properties, which can be included in the above-described image saliency intensity data, are indicative of the overall image quality, such as brightness, blurriness, and contrast, and non-target object properties such as surrounding vegetation and buildings. The target object properties, which can be included in the above-described object saliency intensity data, are indicative of the target objects' quality, such as the target objects' sizes, colors, and their corresponding classes. To take both factors into account, the saliency mapping module 214 can generate a fine-grained saliency map based on the image 102 as described above and the perception quality evaluation module 216 can modify the fine-grained saliency map results to calculate the PQM 112.

In one example, the perception quality evaluation module 216 can create the modified fine-grained saliency map by modifying or annotating the image and/or object saliency intensity data in the original fine-grained saliency map. The modified fine-grained saliency map can include the original fine-grained image saliency intensity data for the entire image 102, the original fine-grained object saliency intensity data for one or more specific objects in the image 102, and annotations of the original fine-grained object saliency intensity data. The annotations can be indicative of true positive or false negative classifications of these particular objects in the image 102, which can be determined by the perception quality evaluation module 216 based on the object detection data 106 generated by the object detection system 104.

To calculate the PQM 112 based on the fine-grained saliency map results, in one example, the perception quality evaluation module 216 can use Equation (5) defined below. More specifically, the perception quality evaluation module 216 can use Equation (5) to calculate the PQM 112 based, in part, on the image and object saliency intensity data in at least one of the original and modified fine-grained saliency map.

$${I}_{P Q M} = mean ( {I}_{S M} ( x , y ) + {\sum }_{i = 1}^{k} {c}_{i} \cdot {I}_{obj} ( {x}_{m} , {y}_{m} ) ) , \qquad ( 5 )$$

where I_{PQM} is the overall PQM, I_{SM} is the original saliency mapping intensity, I_{obj} is the object saliency mapping intensity, and cᵢ is the object detection confidence score.

The model training service 218 can be embodied as one or more software applications or services executing on the computing device 202. For example, the model training service 218 can be embodied as and can include the pixel module 220, the superpixel module 222, the regression module 224, another module, or a combination thereof. The model training service 218 can be executed by the processor 204 to implement (e.g., execute) at least one of the pixel module 220, the superpixel module 222, and the regression module 224. Each of the pixel module 220, the superpixel module 222, and the regression module 224 can also be respectively embodied as one or more software applications or services executing on the computing device 202.

In one example, the model training service 218 can be executed by the processor 204 to train the model 114 to predict the PQM 112 based on the image 102 by using the pixel module 220, the superpixel module 222, and the regression module 224 as described below. For example, the model training service 218 can be executed by the processor 204 to train a neural network regression model such as a superpixel attention-based regression neural network to regress on the PQM 112 based on the image 102. For instance, the model training service 218 can be executed by the processor 204 to train such a superpixel attention-based regression neural network to regress on the PQM 112 based on the image 102 by performing a regression learning process as described below.

The pixel module 220 can be embodied as one or more software applications or services executing on the computing device 202. The pixel module 220 can be executed by the processor 204 to extract detailed, local features (also referred to as “pixel features”) from defined subsets of pixels in the image 102 using a pixel-based attention module. The detailed, local features are also referred to herein as “pixel features” and the defined subsets of pixels in the image 102 are also referred to herein as “image patches.”

To extract such detailed, local features (pixel features) from the image 102, the pixel module 220 can transform the image 102 from a [C×H×W] size to a [C×512×512] size, for example. The pixel module 220 can then separate the transformed version of the image 102 having a size of [C×512×512] into image patches (defined subsets of pixels) that can each have a size of [3×32×32], for example. The pixel module 220 can then stack the image patches and send them to a pixel-based attention module to extract the detailed, local features. The pixel-based attention module can be embodied or implemented as a standard vision transformer (ViT) such as, for instance, a pixel-based ViT having 8 attention heads and 2 attention layers. In one example, the output dimension from such a pixel-based attention module is 1024.

The superpixel module 222 can be embodied as one or more software applications or services executing on the computing device 202. The superpixel module 222 can be executed by the processor 204 to extract coarse, general features from superpixel segmentations of pixels in an image 102 using a superpixel-based attention module. The differences between the superpixel module 222 and the pixel module 220 include the preprocessing steps, the input image shape, and positional encoding methods.

The coarse, general features are also referred to herein as “superpixel features” and the superpixel segmentations of pixels in the image 102 are also referred to herein as “superpixel patches.” Each of the superpixel segmentations or “superpixel patches” can be a set of pixels that are all similar to one another with respect to a certain characteristic or computed property. For instance, the pixels in each superpixel segmentation can all have the same or similar pixel intensity, color, texture, or other characteristic or computed property.

To extract the coarse, general features (superpixel features) from the image 102, the superpixel module 222 can segment the image 102 into superpixel patches (superpixel segmentations). To preprocess the image 102, the superpixel module 222 can implement a simple linear iterative clustering (SLIC) algorithm and/or method to segment the image 102 into such superpixel patches. For instance, the superpixel module 222 can implement the “fast SLIC” algorithm and/or method to generate superpixel patches for the image 102.

The superpixel module 222 can set the number of superpixel patches to be 500, for instance. In one example, the data dimension shape for an image 102 input to the superpixel module 222 can be [6×500], where 500 is the number of superpixel patches, and 6 is the number of features in each of the superpixel patches. In one example, the superpixel module 222 can select the mean and standard deviation of the red, green, and blue (RGB) channels as the input features. For positional encoding, the superpixel module 222 can select the superpixel's size (e.g., the size of the superpixel patches) and two-dimensional (2D) position features. For instance, the superpixel module 222 can obtain the superpixels' size based on the number of pixels in the bounded superpixel patches. The 2D positions are the center point position of their corresponding superpixel patches.

The regression module 224 can be embodied as one or more software applications or services executing on the computing device 202. The regression module 224 can be executed by the processor 204 to regress on the PQM 112 based on the detailed, local features extracted by the pixel module 220 and the coarse, general features extracted by the superpixel module 222 as described above.

After implementing the pixel module 220 and the superpixel module 222, the model training service 218 can concatenate and fuse the extracted detailed, local features and the coarse, general features to facilitate regression of the PQM 112. In particular, after extracting the detailed, local features and the coarse, general features, the model training service 218 can normalize and concatenate such features together for object detection perception quality regression by the regression module 224. In one example, the regression module 224 can be embodied or implemented as a multi-layer perceptron regressor. For instance, the regression module 224 can be embodied or implemented as a two-layer feedforward neural network where the hidden layer size is 18 and the output size is 1.

The sensor fusion module 226 can be embodied as one or more software applications or services executing on the computing device 202. The sensor fusion module 226 can be executed by the processor 204 to perform or implement a sensor fusion process or algorithm to combine sensor data captured by at least one of the object detection system(s) 104 or the perception sensor(s) 234. The sensor data can be in the form of, for instance, image data, video data, observational data, perception data, object detection or classification data, other vision-based or object recognition data, or a combination thereof. To fuse such sensor data, the sensor fusion module 226 can perform or implement a sensor fusion process or algorithm that can include, but is not limited to, a Kalman filter, a Gaussian process, a convolutional neural network, a Dempster-Shafer function, a Bayesian network, or another sensor fusion process or algorithm.

The path planning module 228 can be embodied as one or more software applications or services executing on the computing device 202. The path planning module 228 can be executed by the processor 204 to generate a proposed path for an agent to navigate. The agent can include the object detection systems 104, the computing device 110 or the computing device 116, and the perception sensors 234, among other components. The path planning module 228 can be configured to use a motion planning algorithm to generate the proposed path based on the object detection data 106 that can be generated by the object detection systems 104 based on images and/or other sensor data that has been captured by the perception sensors 234. The path planning module 228 can also be configured to generate the proposed path based on such object detection data 106 and fused sensor data that has been fused by the sensor fusion module 226 as described above.

The control module 230 can be embodied as one or more software applications or services executing on the computing device 202. The control module 230 can be executed by the processor 204 to cause any of the control systems 236 to perform one or more operations to facilitate various control functions of, for instance, an agent that includes the object detection systems 104 and the computing device 110 or the computing device 116. For example, the control module 230 can be implemented to cause any of the control systems 236 to perform one or more control operations that can include, but are not limited to, accelerating, braking, steering, extension, retraction, rotation, powering on, and powering off, among others. In at least one example, the control module 230 can be implemented to cause any of the control systems 236 to perform such control operations based on, for instance, the object detection data 106 and other information in some cases (e.g., sensor data or other data of one or more systems of another agent).

The communications stack 232 can include software and hardware layers to implement data communications such as, for instance, Bluetooth®, Bluetooth® Low Energy (BLE), WiFi®, cellular data communications interfaces, dedicated short-range communications (DSRC) interfaces, or a combination thereof. Thus, the communications stack 232 can be relied upon by the computing device 110 and the computing device 116 to establish DSRC, cellular, Bluetooth®, WiFi®, and other communications channels with the networks 118 and with one another.

The communications stack 232 can include the software and hardware to implement Bluetooth®, BLE, DSRC, and related networking interfaces, which provide for a variety of different network configurations and flexible networking protocols for short-range, low-power wireless communications. The communications stack 232 can also include the software and hardware to implement WiFi® communication, DSRC communication, and cellular communication, which also offers a variety of different network configurations and flexible networking protocols for mid-range, long-range, wireless, and cellular communications. The communications stack 232 can also incorporate the software and hardware to implement other communications interfaces, such as X10®, ZigBee®, Z-Wave®, and others. The communications stack 232 can be configured to communicate various data to and from the computing device 110 and the computing device 116. For example, the communications stack 232 can be configured to allow for the computing device 110 and the computing device 116 to share the image 102, the object detection algorithms implemented by the object detection systems 104, the object detection data 106, the ground truth data 108, the PQMs 112, the model 114, or any combination thereof.

The perception sensors 234 can be embodied as one or more perception sensors that can be included in or coupled (e.g., communicatively, operatively) to and used by, for instance, an agent that can include the object detection systems 104 and the computing device 110 or the computing device 116. In some cases, the perception sensors 234 can be embodied with or directly coupled to the object detection systems 104. The perception sensors 234 can be used to capture or measure sensor data (e.g., observational data) such as, for instance, vision-based sensor data. The sensor data can be indicative of an environment surrounding the agent and can be used by, for instance, the object detection systems 104 to generate the object detection data 106. The perception sensors 234 can include, but are not limited to, a camera (e.g., optical, thermographic), a stereo camera, radar, ultrasound or sonar, a LiDAR sensor, receivers for one or more global navigation satellite systems (GNSS) such as, for instance, the global positioning system (GPS), odometry, an inertial measurement unit (e.g., accelerometer, gyroscope, magnetometer), temperature, precipitation, pressure, and other types of sensors.

The control systems 236 can be embodied as one or more control systems that can be included in or coupled (e.g., communicatively, operatively) to and used by an agent that can include the object detection systems 104 and the computing device 110 or the computing device 116. The control systems 236 can be configured and operable to perform control functions for the agent such as, for instance, automated or semi-automated control functions. The control systems 236 can be embodied as one or more control systems that can include, but are not limited to, a powertrain control system (e.g., for a motor, inverter, battery), a chassis control system (e.g., for brakes, suspension), a steering control system, a lighting and signal control system (e.g., for internal and external lights, blinkers, horn), or another control system.

In one example, the control systems 236 can be configured and operable to perform various control operations such as, for instance, accelerating, braking, steering, extending, retracting, or rotating, among others, based on receipt of instructions from the control module 230 as described above. For example, the control systems 236 can be configured and operable to perform such control operations based on receipt of instructions generated by the control module 230 in response to the object detection data 106 and other information in some cases (e.g., sensor data).

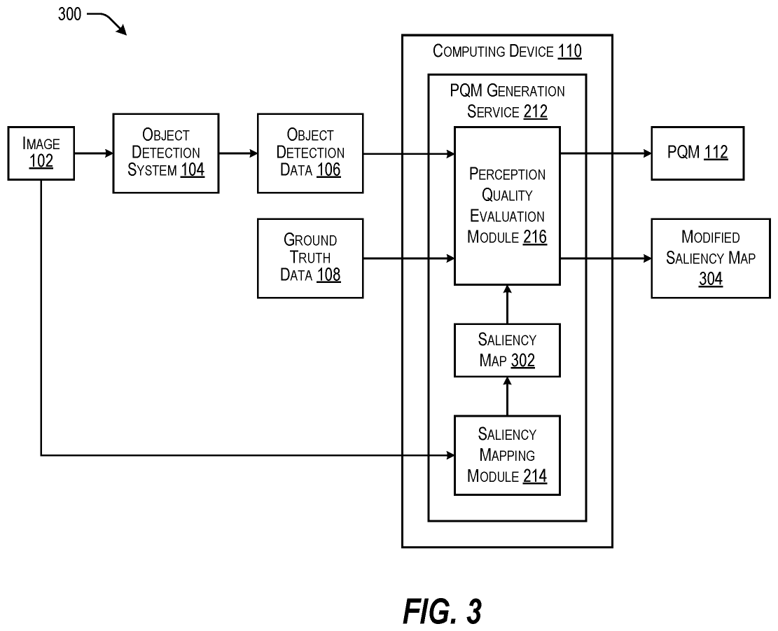

FIG. 3 illustrates a flow diagram of an example data flow 300 that can be implemented to facilitate a perception quality assessment of an object detection system according to at least one embodiment of the present disclosure. In particular, the data flow 300 depicted in FIG. 3 can be implemented to perform the perception quality assessment, saliency map generation, and perception quality metric generation processes described herein. The various operations associated with implementing the data flow 300 are described above with reference to the examples depicted in FIGS. 1 and 2. Therefore, details of such operations are not repeated here for purposes of brevity.

As described above with reference to FIGS. 1 and 2, collectively, the object detection system 104 can generate the object detection data 106 using the image 102 as input. Additionally, the saliency mapping module 214 can perform a fine-grained saliency mapping process using the image 102 to generate a saliency map 302. The saliency map 302 can be embodied or implemented as the fine-grained saliency map described above with reference to FIGS. 1 and 2 that can include saliency intensity data corresponding the image 102. The saliency intensity data can include at least one of image saliency intensity data corresponding to the image 102 as a whole or object saliency intensity data corresponding to one or more objects in the image 102.

As illustrated in FIG. 3, the perception quality evaluation module 216 can receive the object detection data 106 from the object detection system 104 and the saliency map 302 from the saliency mapping module 214. The perception quality evaluation module 216 can further obtain the ground truth data 108 from, for instance, a machine learning training dataset repository or database using the networks 118. For example, the perception quality evaluation module 216 can obtain the ground truth data 108 from an open-source machine learning training dataset repository or database. The perception quality evaluation module 216 can then use the object detection data 106, the ground truth data 108, and the saliency map 302 to evaluate the perception quality of the object detection system 104, create a modified saliency map 304, and calculate the PQM 112 as described above with reference to FIGS. 1 and 2.

The modified saliency map 304 can be embodied or implemented as the modified fine-grained saliency map described above with reference to FIGS. 1 and 2. For example, the perception quality evaluation module 216 can create the modified saliency map 304 such that it denotes any true positive or false negative object detection data that has been correctly or incorrectly classified, respectively, by the object detection system 104 in the object detection data 106. For instance, the perception quality evaluation module 216 can create the modified saliency map 304 such that it denotes the above-described true positive and/or false negative saliency intensity data that can be identified by the perception quality evaluation module 216 in the saliency map 302. In this example, the modified saliency map 304 can denote true positive and/or false negative image and/or object saliency intensity data that has been identified in the saliency map 302 by the perception quality evaluation module 216 as respectively corresponding to true positive and/or false negative classifications in the object detection data 106.

FIG. 4A illustrates an example of the saliency map 302 that can be generated according to at least one embodiment of the present disclosure. As illustrated in FIG. 4A, the saliency map 302 can include at least one of image saliency intensity data 402a, object saliency intensity data 404a, or other saliency intensity data corresponding to an image such as, for instance, the image 102. For purposes of clarity, only one example of each of the image saliency intensity data 402a and the object saliency intensity data 404a are denoted in the saliency map 302 depicted in FIG. 4A.

The image saliency intensity data 402a can be indicative of pixel intensities corresponding to the image 102 as a whole, including pixel intensities for “non-target” objects such as surrounding vegetation and buildings, among others. The object saliency intensity data 404a can be indicative of pixel intensities corresponding to one or more “target” objects in the image 102 such as vehicles, people, traffic signals, and road signs, among others. In one example, the “non-target” objects can be objects in the image 102 that are relatively less important than “target” objects in the image 102 for purposes of object detection and classification operations. In another example, the “non-target” objects can be objects in the image 102 that do not correspond to ground truth labels in the ground truth data 108, while the “target” objects can be objects in the image 102 that do correspond to ground truth labels in the ground truth data 108.

FIG. 4B illustrates an example of the modified saliency map 304 that can be generated according to at least one embodiment of the present disclosure. As illustrated in FIG. 4B, the modified saliency map 304 can include at least one of true positive object saliency intensity data 402b, false negative object saliency intensity data 404b, or other true positive or false negative saliency intensity data that have been identified in the saliency map 302 by the perception quality evaluation module 216. For purposes of clarity, only one example of each of the true positive object saliency intensity data 402b and the false negative object saliency intensity data 404b are denoted in the modified saliency map 304 depicted in FIG. 4B.

As described above with reference to FIGS. 1, 2, and 3, the perception quality evaluation module 216 can create the modified saliency map 304 by identifying true positive and/or false negative image and/or object saliency intensity data in the saliency map 302 that respectively corresponds to true positive and/or false negative classifications in the object detection data 106. The perception quality evaluation module 216 can then create the modified saliency map 304 by annotating the saliency map 302 based on such identified true positive and/or false negative image and/or object saliency intensity data. For example, as illustrated in FIG. 4B, the perception quality evaluation module 216 can create the modified saliency map 304 by annotating the saliency map 302 to denote the true positive object saliency intensity data 402b and the false negative object saliency intensity data 404b.

In the example depicted in FIG. 4B, the true positive object saliency intensity data 402b corresponds to a true positive classification of a first vehicle in the image 102 that was correctly classified by the object detection system 104 in the object detection data 106. In particular, the true positive object saliency intensity data 402b corresponds to a bounding box in the object detection data 106 that includes the first vehicle that was correctly classified by the object detection system 104.

In the example depicted in FIG. 4B, the false negative object saliency intensity data 404b corresponds to a false negative classification of a second vehicle in the image 102 that was incorrectly classified by the object detection system 104 in the object detection data 106. In particular, the false negative object saliency intensity data 404b corresponds to a bounding box in the object detection data 106 that includes the second vehicle that was incorrectly classified by the object detection system 104.

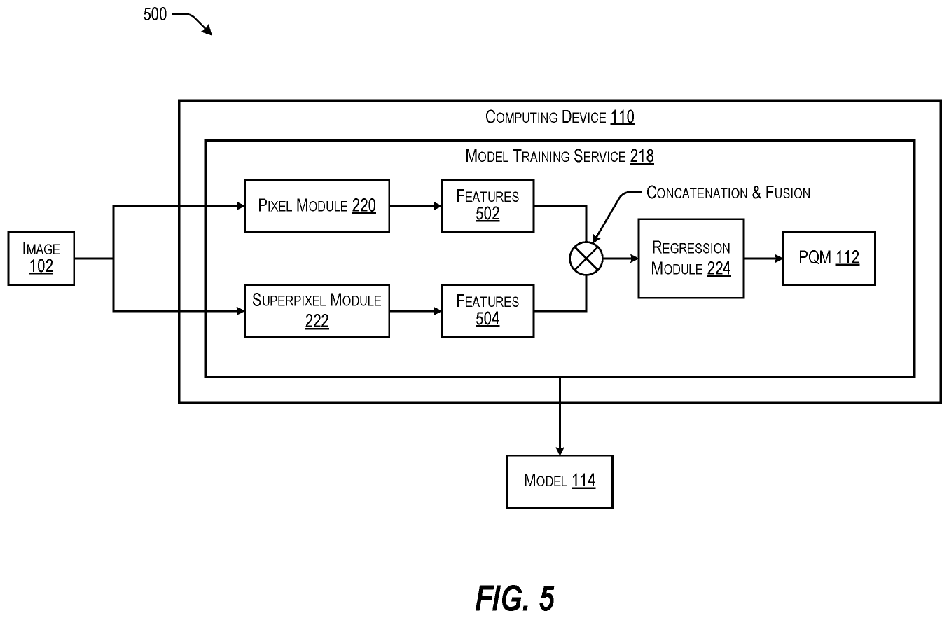

FIG. 5 illustrates a flow diagram of an example data flow 500 that can be implemented to facilitate a perception quality assessment of an object detection system according to at least one embodiment of the present disclosure. In particular, the data flow 500 depicted in FIG. 5 can be implemented to define and train the model 114 to predict the PQM 112 based on the image 102 as described herein. The various operations associated with implementing the data flow 500 are described above with reference to the examples depicted in FIGS. 1 and 2. Therefore, details of such operations are not repeated here for purposes of brevity.

As described above with reference to the examples depicted in FIGS. 1 and 2, collectively, the pixel module 220 can extract detailed, local features (pixel features) from defined subsets of pixels (image patches) in the image 102. These detailed, local features are denoted in FIG. 5 as features 502. Additionally, the superpixel module 222 can extract coarse, general features (superpixel features) from superpixel segmentations (superpixel patches) of the image 102. These coarse, general features are denoted in FIG. 5 as features 504.

After the features 502 and the features 504 have been extracted by the pixel module 220 and the superpixel module 222, respectively, the model training service 218 can concatenate and fuse these features to facilitate regression of the PQM 112 by the regression module 224. In particular, the model training service 218 can normalize and concatenate the features 502 and the features 504 together for object detection perception quality regression by the regression module 224. The regression module 224 can then regress on the PQM 112 based on such concatenated, fused, and normalized features. In this way, the regression module 224 can regress on the PQM 112 based on the image 102. Once trained, the model training service 218 can output the trained version of the model 114 as shown in FIG. 5.

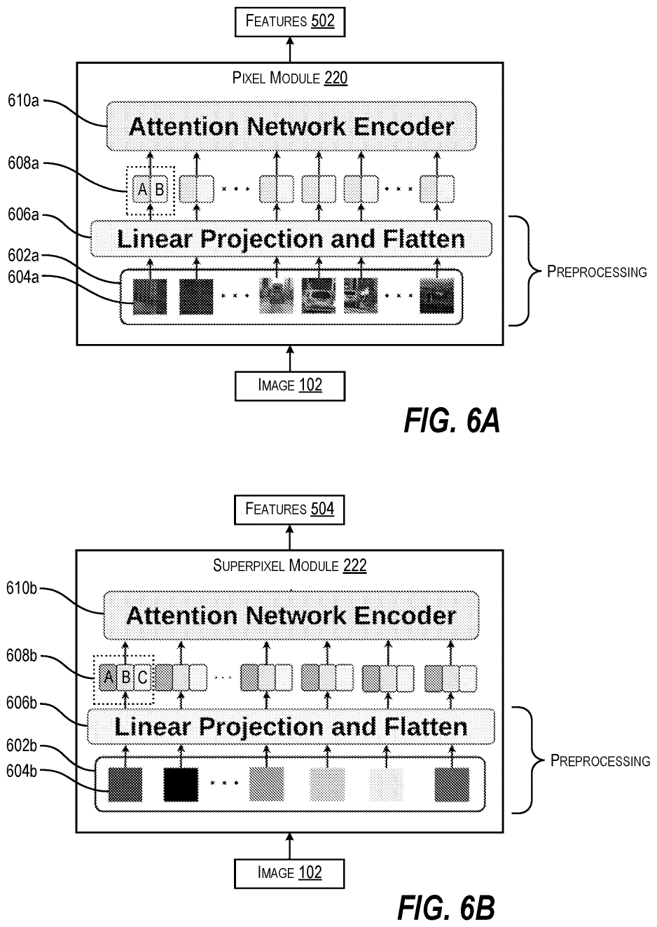

FIG. 6A illustrates a block diagram of an example architecture of the pixel module 220 that can be implemented to facilitate a perception quality assessment of an object detection system according to at least one embodiment of the present disclosure. As illustrated in the example depicted in FIG. 6A, the architecture of the pixel module 220 can include preprocessing layers and an attention network encoder.

In particular, the architecture of the pixel module 220 can include an image patch generation layer 602a that can transform the image 102 from a [C×H×W] size to a [C×512×512] size, for example. The image patch generation layer 602a can then separate the transformed version of the image 102 having a size of [C×512×512] into image patches 604a that can each have a size of [3×32×32], for example. Only a single image patch 604a is denoted in FIG. 6A for purposes of clarity.

The architecture of the pixel module 220 can further include a linear projection and flattening layer 606a that can perform at least one of linear projection operation(s), flattening operation(s), encoding operation(s), or stacking operation(s), or another operation in some cases. For instance, the linear projection and flattening layer 606a can stack the image patches 604a into image patch stacks 608a. The image patch stacks 608a can each include pixel positional encoding A and image patch features B. Only a single image patch stack 608a, pixel positional encoding A, and patch features B are denoted in FIG. 6A for purposes of clarity. In some cases, the linear projection and flattening layer 606a can project the image patches 604a to another dimension, for example, a higher dimension. In some cases, the linear projection and flattening layer 606a can flatten the image patches 604a. In some cases, the linear projection and flattening layer 606a can concatenate the pixel positional encoding A and the image patch features B.

The architecture of the pixel module 220 can further include an attention network encoder 610a that can extract the features 502 from the image patch stacks 608a. The attention network encoder 610a can be embodied or implemented as a pixel-based attention module such as, for instance, a standard vision transformer (ViT). For example, the attention network encoder 610a can be embodied or implemented as a pixel-based ViT having 8 attention heads and 2 attention layers. In one example, the output dimension from the attention network encoder 610a can be 1024.

FIG. 6B illustrates a block diagram of an example architecture of the superpixel module 222 that can be implemented to facilitate a perception quality assessment of an object detection system according to at least one embodiment of the present disclosure. As illustrated in the example depicted in FIG. 6B, the architecture of the superpixel module 222 can include preprocessing layers and an attention network encoder. The differences between the superpixel module 222 and the pixel module 220 include the preprocessing steps, the input image shape, and positional encoding methods.

In particular, the architecture of the superpixel module 222 can include a superpixel patch generation layer 602b that can segment the image 102 into superpixel patches 604b. Only a single superpixel patch 604b is denoted in FIG. 6B for purposes of clarity. Each of the superpixel patches 604b can be a set of pixels that are all similar to one another with respect to a certain characteristic or computed property. For instance, the pixels in each of the superpixel patches 604b can all have the same or similar pixel intensity, color, texture, or other characteristic or computed property.

To preprocess the image 102, the superpixel patch generation layer 602b can implement a simple linear iterative clustering (SLIC) algorithm and/or method to segment the image 102 into the superpixel patches 604b. For instance, the superpixel patch generation layer 602b can implement the “fast SLIC” algorithm and/or method to generate the superpixel patches 604b for the image 102.

At least one of the superpixel module 222 or the superpixel patch generation layer 602b can set the number of superpixel patches 604b to be 500, for instance. In one example, the data dimension shape for the image 102 input to the superpixel module 222 can be [6×500], where 500 is the number of the superpixels patches 604b, and 6 is the number of features in each of the superpixel patches 604b. In one example, at least one of the superpixel module 222 or the superpixel patch generation layer 602b can select the mean and standard deviation of the red, green, and blue (RGB) channels as the input features.

The architecture of the superpixel module 222 can further include a linear projection and flattening layer 606b that can perform at least one of linear projection operation(s), flattening operation(s), encoding operation(s), or stacking operation(s), or another operation in some cases. For instance, the linear projection and flattening layer 606b can stack the superpixel patches 604b into superpixel patch stacks 608b. The superpixel patch stacks 608b can each include superpixel positional encoding A, superpixel size encoding B, and superpixel patch features C. Only a single superpixel patch stack 608b, superpixel positional encoding A, superpixel size encoding B, and superpixel patch features C are denoted in FIG. 6B for purposes of clarity.

In some cases, the linear projection and flattening layer 606b can project the superpixel patches 604b to another dimension, for example, a higher dimension. In some cases, the linear projection and flattening layer 606b can flatten the superpixel patches 604b. In some cases, the linear projection and flattening layer 606b can concatenate the superpixel positional encoding A, the superpixel size encoding B, and the superpixel patch features C.

For the superpixel positional encoding A, at least one of the superpixel module 222 or the linear projection and flattening layer 606b can select the size of the superpixel patches 604b and two-dimensional (2D) position features. For instance, at least one of the superpixel module 222 or the superpixel patch generation layer 602b can obtain the size of the superpixel patches 604b based on the number of pixels in the bounded superpixel patches (e.g., the number of pixels in the superpixel patches 604b). The 2D positions are the center point position of their corresponding superpixel patches (e.g., the center point position of their corresponding superpixel patches 604b).

The architecture of the superpixel module 222 can further include an attention network encoder 610b that can extract the features 504 from the superpixel patch stacks 608b. The attention network encoder 610b can be embodied or implemented as a superpixel-based attention module such as, for instance, a standard vision transformer (ViT). For example, the attention network encoder 610b can be embodied or implemented as a superpixel-based ViT having 8 attention heads and 2 attention layers. In one example, the output dimension from the attention network encoder 610b can be 1024.

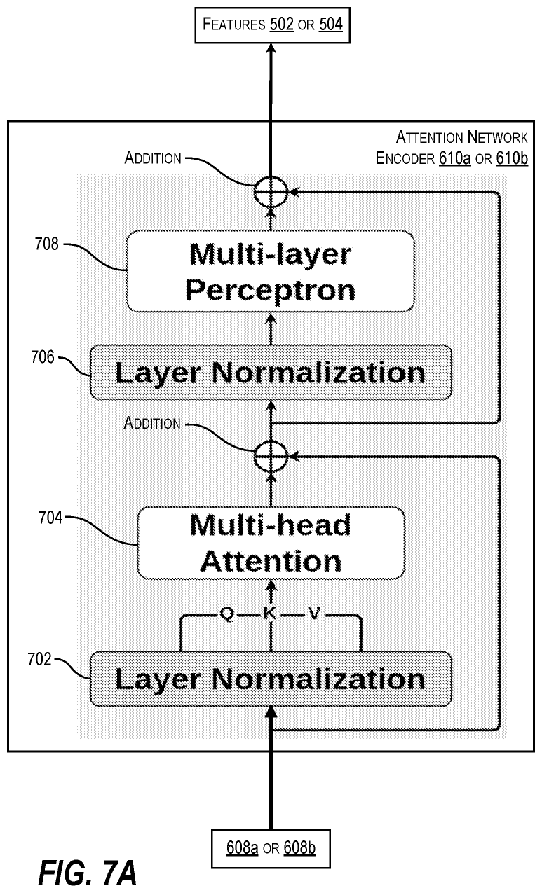

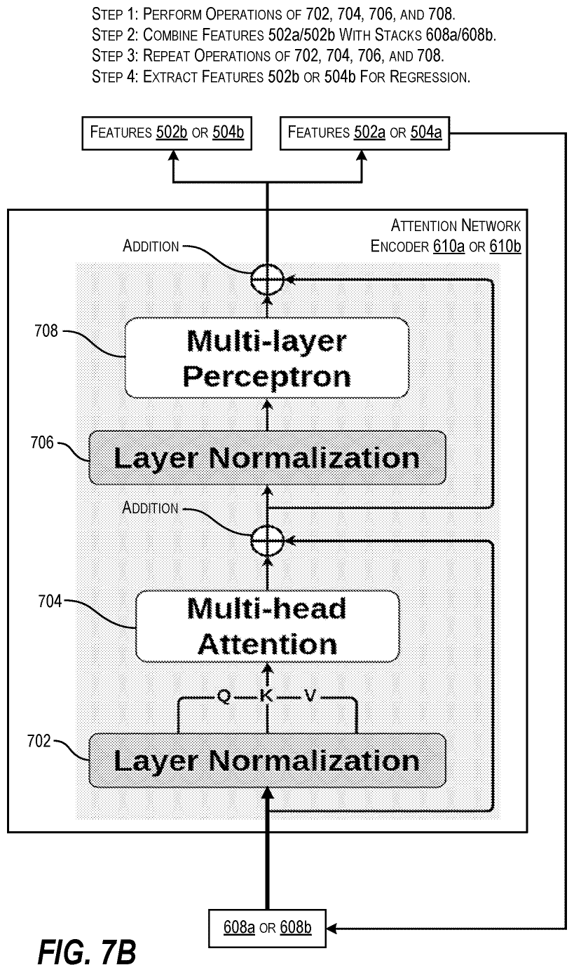

FIG. 7A illustrates a block diagram of an example architecture and data flow of the attention network encoder 610a of the pixel module 220 and the attention network encoder 610b of the superpixel module 222 that can be implemented to facilitate a perception quality assessment of an object detection system according to at least one embodiment of the present disclosure. The differences between the attention network encoder 610a and the attention network encoder 610b include the use of the image patch stacks 608a or the superpixel patch stacks 608b as input, respectively, and the extraction of the features 502 or the features 504, respectively.

As illustrated in the example depicted in FIG. 7A, the architecture of each of the attention network encoders 610a, 610b can include a first normalization layer 702 (denoted as “layer normalization” in FIG. 7A), a multi-head attention layer 704, a second normalization layer 706 (denoted as “layer normalization” in FIG. 7A), and a multi-layer perceptron layer 708.

For the attention network encoder 610a, the first normalization layer 702 can generate the query (Q), key (K), and value (V) matrices from the image patch stacks 608a. For instance, the first normalization layer 702 can generate a Q matrix, a K matrix, and a V matrix from each of the image patch stacks 608a. Similarly, for the attention network encoder 610b, the first normalization layer 702 can generate the Q, K, and V matrices from the superpixel patch stacks 608b. For instance, the first normalization layer 702 can generate a Q matrix, a K matrix, and a V matrix from each of the superpixel patch stacks 608b.

For each of the attention network encoders 610a, 610b, the multi-head attention layer 704 can perform a softmax operation using the Q, K, and V matrices generated by the first normalization layer 702. For the attention network encoder 610a, the attention network encoder 610a can then perform an addition operation to combine the image patch stacks 608a with the output of the multi-head attention layer 704. Similarly, for the attention network encoder 610b, the attention network encoder 610b can then perform an addition operation to combine the superpixel patch stacks 608b with the output of the multi-head attention layer 704.

For the attention network encoder 610a, the second normalization layer 706 can normalize the combined output data of the multi-head attention layer 704 and the image patch stacks 608a input to the attention network encoder 610a. The normalized combined data output by the second normalization layer 706 can then pass through the multi-layer perceptron layer 708. The attention network encoder 610a can then combine the data output by the multi-layer perceptron layer 708 with the combined output data of the multi-head attention layer 704 and the image patch stacks 608a input to the attention network encoder 610a.

Similarly, for the attention network encoder 610b, the second normalization layer 706 can normalize the combined output data of the multi-head attention layer 704 and the superpixel patch stacks 608b input to the attention network encoder 610b. The normalized combined data output by the second normalization layer 706 can then pass through the multi-layer perceptron layer 708. The attention network encoder 610b can then combine the data output by the multi-layer perceptron layer 708 with the combined output data of the multi-head attention layer 704 and the superpixel patch stacks 608b input to the attention network encoder 610b.

FIG. 7B illustrates a block diagram of another example architecture and data flow of the attention network encoder 610a of the pixel module 220 and the attention network encoder 610b of the superpixel module 222 that can be implemented to facilitate a perception quality assessment of an object detection system according to at least one embodiment of the present disclosure. The architecture and data flow illustrated in FIG. 7B is an example alternative embodiment of the architecture and data flow described herein and illustrated in FIG. 7A. The difference between the architecture and data flow illustrated in FIG. 7B and the architecture and data flow illustrated in FIG. 7A is that the above-described operations of each of the attention network encoders 610a, 610b in the architecture of FIG. 7B are performed a first time and then repeated a second time using features extracted from the first round of operations as input for the second round of operations to augment regression results described in examples herein.

In the example shown in FIG. 7B, each of the attention network encoders 610a, 610b performs the operations of the first normalization layer 702, the multi-head attention layer 704, the second normalization layer 706, and the multi-layer perceptron layer 708 a first time as described above with reference to FIG. 7A to extract first features 502a or 504a. Each of the attention network encoders 610a, 610b in this example then combines the first features 502a or 504a with the image patch stacks 608a or the superpixel patch stacks 608b and then repeats the operations of the first normalization layer 702, the multi-head attention layer 704, the second normalization layer 706, and the multi-layer perceptron layer 708 a second time using the first features 502a or 504a and the image patch stacks 608a or the superpixel patch stacks 608b as input. In this example, each of the attention network encoders 610a, 610b then extracts second features 502b or 504b after performing the second round of operations using the first features 502a or 504a and the image patch stacks 608a or the superpixel patch stacks 608b as input. In this way, the attention network encoders 610a, 610b can provide relatively better regression results while limiting the computational costs associated with training the model 114 to predict the PQM 112.

Each of the first features 502a, 504a and each of the second features 502b, 504b are embodied and implemented in the same manner as the above-described features 502, 504, respectively. For instance, each of the first features 502a, 504a and each of the second features 502b, 504b has the same structure, attributes, and functionality as that of the features 502, 504, respectively.

In some examples, after the attention network encoder 610a performs the above-described operations of the first normalization layer 702, the multi-head attention layer 704, the second normalization layer 706, and the multi-layer perceptron layer 708 a first time to extract the first features 502a, it can then use the first features 502a and the image patch stacks 608a as input to perform the same operations a second time. In these examples, after performing such operations a second time using the first features 502a and the image patch stacks 608a as input, the attention network encoder 610a can extract the second features 502b. In these examples, the second features 502b can be sent to the regression module 224 for regression.

In other examples, after the attention network encoder 610b performs the above-described operations of the first normalization layer 702, the multi-head attention layer 704, the second normalization layer 706, and the multi-layer perceptron layer 708 a first time to extract the first features 504a, it can then use the first features 504a and the superpixel patch stacks 608b as input to perform the same operations a second time. In these examples, after performing the above-described operations a second time using the first features 504a and the superpixel patch stacks 608b as input, the attention network encoder 610b can extract the second features 504b. In these examples, the second features 504b can be sent to the regression module 224 for regression.

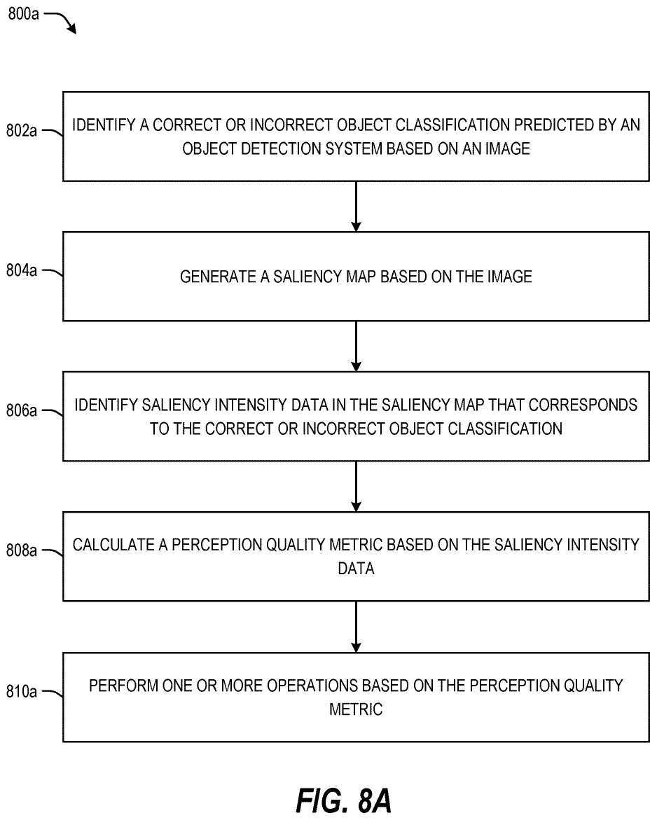

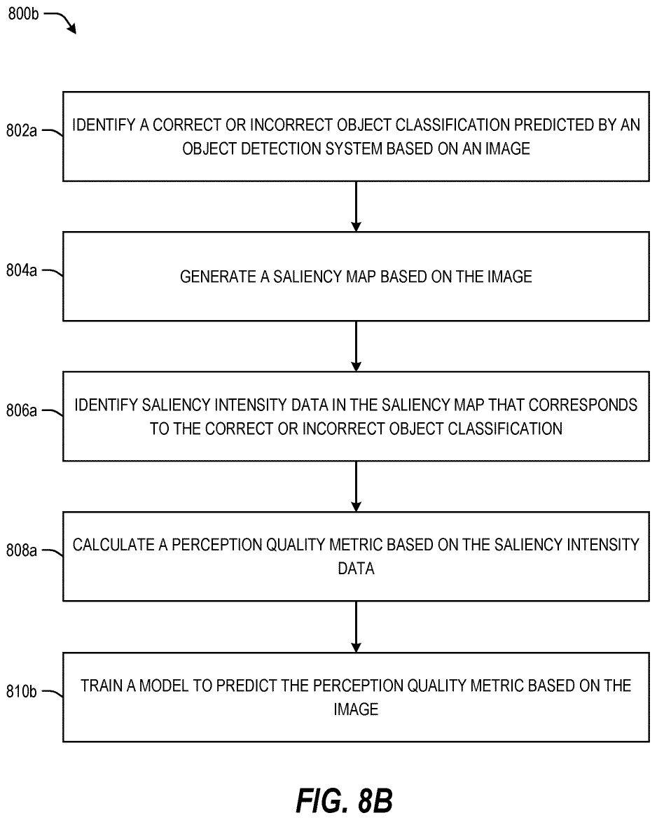

FIG. 8A illustrates a flow diagram of an example computer-implemented method 800a that can be implemented to facilitate a perception quality assessment of an object detection system according to at least one embodiment of the present disclosure. In one example, the computer-implemented method 800a (hereinafter, “the method 800a”) can be implemented by the computing device 110. In another example, the method 800a can be implemented by the computing device 116. The method 800a can be implemented in the context of the environment 100, the computing environment 200 or another environment, the data flow 300, and the data flow 500. In one example, the method 800a can be implemented to perform one or more of the operations described herein with reference to the examples depicted in FIGS. 1, 2, 3, 4A, 4B, 5, 6A, 6B, 7A, and 7B.

At 802a, the method 800a can include identifying a correct or incorrect object classification predicted by an object detection system based on an image. For example, the computing device 110 can identify at least one of true positive or false negative object detection data in the object detection data 106 that can be generated by the object detection system 104 based on the image 102. For instance, the computing device 110 can identify at least one of true positive or false negative object detection data in the object detection data 106 based on the ground truth data 108 corresponding to the image 102. In particular, the computing device 110 can identify a true positive (correct) classification or a false negative (incorrect) classification of an object in the object detection data 106 based on a ground truth label in the ground truth data 108 that is indicative of the object.

At 804a, the method 800a can include generating a saliency map based on the image. For example, the computing device 110 can generate a fine-grained saliency map such as, for instance, the saliency map 302 that can include saliency intensity data corresponding to the image 102. For instance, the saliency map 302 can include at least one of the image saliency intensity data 402a, the object saliency intensity data 404a, or other saliency intensity data corresponding to the image 102.

At 806a, the method 800a can include identifying saliency intensity data in the saliency map that corresponds to the correct or incorrect object classification. For example, the computing device 110 can identify saliency intensity data in the saliency map 302 that respectively corresponds to at least one of true positive or false negative object detection data in the object detection data 106. For instance, the computing device 110 can use the ground truth data 108 to identify saliency intensity data in the saliency map 302 that respectively corresponds to a true positive (correct) classification or a false negative (incorrect) classification of an object in the object detection data 106.

At 808a, the method 800a can include calculating a perception quality metric based on the saliency intensity data. For example, the computing device 110 can calculate the PQM 112 for the object detection system 104 based on at least one of true positive or false negative saliency intensity data in the saliency map 302 that respectively corresponds to a true positive (correct) classification or a false negative (incorrect) classification of an object in the object detection data 106. The PQM 112 can be indicative of a degree of perception quality of the object detection system 104 with respect to the image 102.

At 810a, the method 800a can include performing one or more operations based on the perception quality metric. For example, the computing device 110 can perform at least one of an object detection system selection operation, a path planning operation, a control operation, a sensor selection operation, a sensor fusion operation, or another operation based on the PQM 112. As described herein with reference to FIG. 8B, in some examples the computing device 110 can perform a regression learning process to train the model 114 to predict the PQM 112 based on the image 102.

FIG. 8B illustrates a flow diagram of another example computer-implemented method 800b that can be implemented to facilitate a perception quality assessment of an object detection system according to at least one embodiment of the present disclosure. In one example, the computer-implemented method 800b (hereinafter, “the method 800b”) can be implemented by the computing device 110. In another example, the method 800b can be implemented by the computing device 116. The method 800b can be implemented in the context of the environment 100, the computing environment 200 or another environment, the data flow 300, and the data flow 500. In one example, the method 800b can be implemented to perform one or more of the operations described herein with reference to the examples depicted in FIGS. 1, 2, 3, 4A, 4B, 5, 6A, 6B, 7A, and 7B. The method 800b is an example alternative embodiment of the method 800a described herein and illustrated in FIG. 8A. The difference between the method 800b and the method 800a is that the method 800b is directed to an example application of the perception quality metric calculated at operation 808a of the method 800a.

As illustrated in FIG. 8B, the method 800b can include operations 802a, 804a, 806a, 808a of the method 800a, which can be implemented to calculate the perception quality metric at operation 808a as described herein with reference to FIG. 8A. At 810b, the method 800b can further include training a model to predict the perception quality metric based on the image of operations 802a, 804a. For example, the computing device 110 (e.g., via the model training service 218) can perform a regression learning process to train a machine learning or artificial intelligence model to predict the perception quality metric based on the image as described herein with reference to FIGS. 1, 2, 5, 6A, 6B, 7A, and 7B. In some examples, the image can be representative of input training data in the regression learning process and the perception quality metric can be representative of a ground truth label in the regression learning process.

In one example, the computing device 110 can perform a regression learning process to train the model 114 to predict the PQM 112 based on the image 102. In this example, the computing device 110 (e.g., via the model training service 218) can perform a regression learning process to train the model 114 to predict the PQM 112 based on local features extracted from defined subsets of pixels in the image 102 and general features extracted from superpixel segmentations of pixels in the image 102 as described herein with reference to FIGS. 1, 2, 5, 6A, 6B, 7A, and 7B. For instance, the computing device 110 (e.g., via the model training service 218) can implement the pixel module 220 to extract local features (e.g., the features 502, 502a, 502b) from defined subsets of pixels in the image 102 using a pixel-based attention module (e.g., the attention network encoder 610a). The computing device 110 (e.g., via the model training service 218) can also implement the superpixel module 222 to extract general features (e.g., the features 504, 504a, 504b) from superpixel segmentations of pixels in the image 102 using a superpixel-based attention module (the attention network encoder 610b). The computing device 110 (e.g., via the model training service 218) can then implement the regression module 224 to regress on the PQM 112 based on the extracted local and general features.

Referring now to FIG. 2, an executable program can be stored in any portion or component of the memory 206 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 206 can include both volatile and nonvolatile memory and data storage components. Volatile components are those that do not retain data values upon loss of power. Nonvolatile components are those that retain data upon a loss of power. Thus, the memory 206 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the PQM generation service 212, the saliency mapping module 214, the perception quality evaluation module 216, the model training service 218, the pixel module 220, the superpixel module 222, the regression module 224, the sensor fusion module 226, the path planning module 228, the control module 230, and the communications stack 232 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIGS. 8A and 8B, the flowchart or process diagram shown in each of FIGS. 8A and 8B is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 204. The machine code can be converted from the source code. Further, each block can represent, or be connected with, a circuit or a number of interconnected circuits to implement a certain logical function or process step.

Although the flowchart or process diagram shown in each of FIGS. 8A and 8B illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the PQM generation service 212, the saliency mapping module 214, the perception quality evaluation module 216, the model training service 218, the pixel module 220, the superpixel module 222, the regression module 224, the sensor fusion module 226, the path planning module 228, the control module 230, and the communications stack 232 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in each of FIGS. 8A and 8B. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Additional details related to the above-described embodiments of the present disclosure are also described in the attached APPENDIX A.

Therefore, at least the following is claimed:

1. A method to assess perception quality of an object detection system, the method comprising:
identifying, by a computing device, at least one of true positive or false negative object detection data in object detection data generated by the object detection system based on an image;
generating, by the computing device, a saliency map based on the image, the saliency map comprising saliency intensity data corresponding to the image;
identifying, by the computing device, at least one of true positive or false negative saliency intensity data in the saliency map based on at least one of the true positive or false negative object detection data, respectively;
calculating, by the computing device, a perception quality metric based on at least one of the true positive or false negative saliency intensity data, the perception quality metric being indicative of a degree of perception quality of the object detection system with respect to the image; and
performing, by the computing device, one or more operations based on the perception quality metric.

2. The method of claim 1, wherein identifying at least one of the true positive or false negative object detection data in the object detection data comprises:
identifying, by the computing device, at least one of the true positive or false negative object detection data in the object detection data based on ground truth data corresponding to the image.

3. The method of claim 1, wherein identifying at least one of the true positive or false negative object detection data in the object detection data comprises:
identifying, by the computing device, a true positive classification or a false negative classification of an object in the object detection data based on a ground truth label indicative of the object.

4. The method of claim 1, wherein generating the saliency map based on the image comprises:
performing, by the computing device, a fine-grained saliency mapping process based on the image to generate a fine-grained saliency map comprising at least one of image saliency intensity data corresponding to the image as a whole or object saliency intensity data corresponding to one or more objects in the image.

5. The method of claim 1, wherein identifying at least one of the true positive or false negative saliency intensity data in the saliency map based on at least one of the true positive or false negative object detection data, respectively, comprises:
identifying, by the computing device, object saliency intensity data in the saliency map that is indicative of an object in the image and that corresponds to a true positive classification or a false negative classification of the object in the object detection data.

6. The method of claim 1, wherein performing the one or more operations based on the perception quality metric comprises:
comparing, by the computing device, the perception quality metric with a second perception quality metric corresponding to a second object detection system, the second perception quality metric being indicative of a second degree of perception quality of the second object detection system with respect to the image; and
implementing, by the computing device, the object detection system or the second object detection system based on a comparison of the perception quality metric with the second perception quality metric.

7. The method of claim 1, wherein performing the one or more operations based on the perception quality metric comprises:
performing, by the computing device, at least one of a path planning operation, a control operation, a sensor selection operation, or a sensor fusion operation based on the perception quality metric.

8. The method of claim 1, wherein performing the one or more operations based on the perception quality metric comprises:
performing, by the computing device, a regression learning process to train a model to predict the perception quality metric based on the image, the image being representative of input training data in the regression learning process and the perception quality metric being representative of a ground truth label in the regression learning process.

9. The method of claim 1, wherein performing the one or more operations based on the perception quality metric comprises:
performing, by the computing device, a regression learning process to train a model to predict the perception quality metric based on local features extracted from defined subsets of pixels in the image and general features extracted from superpixel segmentations of pixels in the image.

10. The method of claim 1, wherein performing the one or more operations based on the perception quality metric comprises:
performing, by the computing device, a regression learning process to train a model to predict the perception quality metric based on the image, the regression learning process comprising:
implementing, by the computing device, a pixel module to extract local features from defined subsets of pixels in the image using a pixel-based attention module;
implementing, by the computing device, a superpixel module to extract general features from superpixel segmentations of pixels in the image using a superpixel-based attention module; and
implementing, by the computing device, a regression module to regress on the perception quality metric based on the local features and the general features.

11. A computing device, comprising:
a memory device to store computer-readable instructions thereon; and
at least one processing device configured through execution of the computer-readable instructions to:
identify at least one of true positive or false negative object detection data in object detection data generated by an object detection system based on an image;
generate a saliency map based on the image, the saliency map comprising saliency intensity data corresponding to the image;
identify at least one of true positive or false negative saliency intensity data in the saliency map based on at least one of the true positive or false negative object detection data, respectively;
calculate a perception quality metric based on at least one of the true positive or false negative saliency intensity data, the perception quality metric being indicative of a degree of perception quality of the object detection system with respect to the image; and
perform one or more operations based on the perception quality metric.

12. The computing device of claim 11, wherein, to identify at least one of the true positive or false negative object detection data in the object detection data, the at least one processing device is further configured to:
identify a true positive classification or a false negative classification of an object in the object detection data based on a ground truth label indicative of the object.

13. The computing device of claim 11, wherein, to identify at least one of the true positive or false negative saliency intensity data in the saliency map based on at least one of the true positive or false negative object detection data, respectively, the at least one processing device is further configured to:
identify object saliency intensity data in the saliency map that is indicative of an object in the image and that corresponds to a true positive classification or a false negative classification of the object in the object detection data.

14. The computing device of claim 11, wherein, to perform the one or more operations, the at least one processing device is further configured to:
compare the perception quality metric with a second perception quality metric corresponding to a second object detection system, the second perception quality metric being indicative of a second degree of perception quality of the second object detection system with respect to the image; and
implement the object detection system or the second object detection system based on a comparison of the perception quality metric with the second perception quality metric.

15. The computing device of claim 11, wherein, to perform the one or more operations, the at least one processing device is further configured to:
perform at least one of a path planning operation, a control operation, a sensor selection operation, or a sensor fusion operation based on the perception quality metric.

16. The computing device of claim 11, wherein, to perform the one or more operations, the at least one processing device is further configured to:
perform a regression learning process to train a model to predict the perception quality metric based on local features extracted from defined subsets of pixels in the image and general features extracted from superpixel segmentations of pixels in the image.

17. The computing device of claim 11, wherein, to perform the one or more operations, the at least one processing device is further configured to:
perform a regression learning process to train a model to predict the perception quality metric based on the image, and wherein, to perform the regression learning process, the at least one processing device is further configured to:
implement a pixel module to extract local features from defined subsets of pixels in the image using a pixel-based attention module;
implement a superpixel module to extract general features from superpixel segmentations of pixels in the image using a superpixel-based attention module; and
implement a regression module to regress on the perception quality metric based on the local features and the general features.

18. A non-transitory computer-readable medium embodying at least one program that, when executed by at least one computing device, directs the at least one computing device to:
identify at least one of true positive or false negative object detection data in object detection data generated by an object detection system based on an image;
generate a saliency map based on the image, the saliency map comprising saliency intensity data corresponding to the image;
identify at least one of true positive or false negative saliency intensity data in the saliency map based on at least one of the true positive or false negative object detection data, respectively;
calculate a perception quality metric based on at least one of the true positive or false negative saliency intensity data, the perception quality metric being indicative of a degree of perception quality of the object detection system with respect to the image; and
perform one or more operations based on the perception quality metric.

19. The non-transitory computer-readable medium according to claim 18, wherein, to perform the one or more operations, the at least one computing device is further directed to:
compare the perception quality metric with a second perception quality metric corresponding to a second object detection system, the second perception quality metric being indicative of a second degree of perception quality of the second object detection system with respect to the image; and
implement the object detection system or the second object detection system based on a comparison of the perception quality metric with the second perception quality metric.

20. The non-transitory computer-readable medium according to claim 18, wherein, to perform the one or more operations, the at least one computing device is further directed to:
perform a regression learning process to train a model to predict the perception quality metric based on the image, and wherein, to perform the regression learning process, the at least one computing device is further directed to:
implement a pixel module to extract local features from defined subsets of pixels in the image using a pixel-based attention module;
implement a superpixel module to extract general features from superpixel segmentations of pixels in the image using a superpixel-based attention module; and
implement a regression module to regress on the perception quality metric based on the local features and the general features.
